(19) United States
(12) Patent Application Publication
(10) Pub. No.: US 2016/0006519 A1
(43) Pub. Date: Jan. 7, 2016

(54) Quantum Transceiver

(71) Applicant: Anderson Lail, Logansport, IN (US)

(72) Inventor: Anderson Lail, Logansport, IN (US)

(21) Appl. No.: 14/791,815

(22) Filed: Jul. 6, 2015

Related U.S. Application Data
(60) Provisional application No. 62/021,496, filed on Jul. 7, 2014.

(51) Int. Cl. H04B 10/90

(52) U.S. Cl. CPC H04B 10/90; Y10S 977/933

(57) ABSTRACT

A quantum transceiver including a network interface card containing a quantum link controller, multiple send circuits, receive circuits, clock and data recovery circuits, and circuits for future implementation for added functionality or for testing purposes. Each send and receive circuit is entangled with its opposite on a separate interface card, and this entangled grouping can be described as a quantum link.

### FIELD OF THE INVENTION

This invention relates generally to communications and quantum mechanics. More particularly, it relates to using quantum theory to facilitate instantaneous communication between two or more devices, such as network adapters, routers, and switches.

### BACKGROUND

In all current networks, there exists a possibility of monitoring, distorting, intercepting the signal, and spectrum exhaustion. Also, the communications industry utilizes a large connective infrastructure that is vulnerable, expensive to implement and maintain. Latency is an on-going bottleneck in the field of network communication. The higher the number of participants on the network and the greater the distance covered by the network, the greater the latency. Network adapters enable connectivity throughout the infrastructure.

Existing network adapters enable connectivity throughout infrastructures ranging from wireless radios to complex fiber optic networks, and satellite communications. There are several types of network adapters, both wired and wireless, and of many different topologies. One prevalent topology is Ethernet which uses fiber, twisted-pair cabling and radio frequencies as its primary physical layer of connectivity.

The device of this disclosure addresses, in one aspect, the continuing challenge of the latency related to transferring data. The device addresses this challenge by using quantum entanglement to facilitate communication between nodes. By utilizing quantum theory in operation according to this disclosure, traditional high-cost communication infrastructure may be reduced.

Researchers have discovered how to create a range of materials with quantum mechanical properties. A deep center defect in diamond nanocrystals, called the nitrogen vacancy center, has the characteristics and qualities needed to hold a single electron in a stable condition. A nanocrystal is a material particle having at least one dimension smaller than 100 nanometers (a nanoparticle) and composed of atoms in either a single- or poly-crystalline arrangement.

Additionally, researchers have discovered how to manipulate the spin state of an electron by use of tunable microwave magnetic fields. Microwaves are a form of electromagnetic radiation, and an electromagnetic field is a physical field produced by electrically charged objects. Microwave magnetic fields have been shown to affect the behavior of charged objects in the vicinity of the field.

Researchers have also discovered how to read the spin state of an electron through measurement of in-plane magnetic field tolerance or resonant gate-based readouts utilizing a resonant LC circuit tuned to a specific range. Utilizing this art as a foundation, the invention of the current disclosure provides the means to send and receive data via quantum state changes with negligible delay.

Quantum entanglement is a physical phenomenon that occurs when pairs or groups of particles are generated, or interact, in ways such that the quantum state of each particle cannot be described independently. Instead, a quantum state may be given for the system as a whole. That is, quantum entanglement is the phenomenon where two or more particles, despite physical separation, react as if they are one entity. The resulting physical phenomenon is the following: if an individual facilitates a change to one particle, the other particle exhibits a complimentary change. One important aspect is that no measurable time passes as the changes in states are reflected. Therefore, if one particle, “Particle A,” is changed in some way, the other particle, “Particle B,” instantly reflects the change as well.

Measurements of physical properties such as position, momentum, spin, polarization, etc., performed on entangled particles are found to be appropriately correlated. For example, if a pair of particles is generated in such a way that their total spin is known to be zero, and one particle is found to have clockwise spin on a certain axis, then the spin of the other particle, measured on the same axis, will be found to be counterclockwise; because of the nature of quantum measurement, however, this behavior gives rise to effects that can appear paradoxical: any measurement of a property of a particle can be seen as acting on that particle (e.g. by collapsing a number of superpositioned states); and in the case of entangled particles, such action must be on the entangled system as a whole. It thus appears that one particle of an entangled pair “knows” what measurement has been performed on the other, and with what outcome, even though the means for such information being communicated between the particles is not well understood, which at the time of measurement may be separated by arbitrarily large distances.

Such phenomena were the subject of a 1935 paper by Albert Einstein, Boris Podolsky and Nathan Rosen, and several papers by Erwin Schrodinger shortly thereafter, describing what came to be known as the EPR paradox. Einstein and others considered such behavior to be impossible, as it violated the local realist view of causality (Einstein referred to it as “spooky action at a distance”), and argued that the accepted formulation of quantum mechanics must therefore be incomplete. Later, however, the counterintuitive predictions of quantum mechanics were verified experimentally. Experiments have been performed involving measuring the polarization or spin of entangled particles in different directions, which—by producing violations of Bell's inequality—demonstrate statistically that the local realist view cannot be correct. This has been shown to occur even when the measurements are performed more quickly than light could travel between the sites of measurement: there is no lightspeed or slower influence that can pass between the entangled particles. Recent experiments have measured entangled particles within less than one one-hundredth of a percent of the light travel time between them.

In telecommunications and computer networking, a communication link or channel refers either to a physical transmission medium such as a wire, or to a logical connection over a multiplexed medium such as a radio channel. A channel is used to convey an information signal, for example a digital bit stream, from one or several senders (or transmitters) to one or several receivers. A channel has a certain capacity for transmitting information, often measured by its bandwidth in Hz or its data rate in bits per second.

Communicating data from one location to another requires some form of pathway or medium. These pathways, called communication channels, use two types of media: cable (twisted-pair wire, cable, and fiber-optic cable) and broadcast (microwave, satellite, radio, and infrared). Cable or wire line media use physical wires or cables to transmit data and information. Twisted-pair wire and coaxial cables are made of copper, and fiber-optic cable is made of glass.

Flip-flops and latches are a fundamental building block of digital electronics systems used in computers, communications, and many other types of systems. In electronics, a flip-flop or latch is a circuit that has two stable states and can be used to store state information. It is the basic storage element in sequential logic.

Flip-flops and latches are used as data storage elements. A flip-flop stores a single bit (binary digit) of data; one of its two states represents a “one” and the other represents a “zero.” Such data storage can be used for storage of state, and such a circuit is described as sequential logic. It can also be used for counting of pulses, and for synchronizing variably-timed input signals to some reference timing signal. Flip-flops can be either simple or clocked. It is common to reserve the term flip-flop exclusively for discussing clocked circuits; the simple ones are commonly called latches.

In electronics, signal conditioning means manipulating an analog signal in such a way that it meets the requirements of the next stage for further processing. Most common use is in analog-to-digital converters.

A simple voltage regulator can be made from a resistor in series with a diode (or series of diodes). Due to the logarithmic shape of diode V-I curves, the voltage across the diode changes only slightly due to changes in current drawn or changes in the input.

Feedback voltage regulators operate by comparing the actual output voltage to some fixed reference voltage. Any difference is amplified and used to control the regulation element in such a way as to reduce the voltage error. This forms a negative feedback control loop; increasing the open-loop gain tends to increase regulation accuracy but reduce stability as measured by avoidance of oscillation, or ringing, during step changes. There will also be a trade-off between stability and the speed of the response to changes. If the output voltage is too low—perhaps due to input voltage reducing or load current increasing—the regulation element is partly commanded to produce a higher output voltage by dropping less of the input voltage (for linear series regulators and buck switching regulators), or to draw input current for longer periods (boost-type switching regulators). If the output voltage is too high, the regulation element will normally be commanded to produce a lower voltage. However, many regulators have over-current protection, so that they will limit or entirely stop sourcing current if the output current is too high, and some regulators may also shut down if the input voltage is outside a given range.

A waveguide is a structure that guides waves, such as electromagnetic waves or sound waves. There are different types of waveguides for each type of wave. In electromagnetics and communications engineering, the term waveguide may refer to any linear structure that conveys electromagnetic waves between its endpoints. Waveguide propagation modes depend on the operating wavelength and polarization and the shape and size of the guide.

Microwaves are a form of electromagnetic radiation with wavelengths ranging from as long as one meter to as short as one millimeter; with frequencies between 300 MHz (100 cm) and 300 GHz (0.1 cm). The term microwave also has a specific meaning in electromagnetics and circuit theory. Apparatus and techniques may be described qualitatively as “microwave” when the frequencies used are high enough that wavelengths of signals are roughly the same as the dimensions of the equipment, so that lumped-element circuit theory is inaccurate. As a consequence, practical microwave technique tends to move away from the discrete resistors, capacitors, and inductors used with lower-frequency radio waves. Instead, distributed circuit elements and transmission-line theory are more useful methods for design and analysis. Open-wire and coaxial transmission lines used at lower frequencies are replaced by waveguides and stripline, and lumped-element tuned circuits are replaced by cavity resonators or resonant lines. In turn, at even higher frequencies, where the wavelength of the electromagnetic waves becomes small in comparison to the size of the structures used to process them, microwave techniques become inadequate, and the methods of optics are used.

A logic gate is an elementary building block of a digital circuit. Most logic gates have two inputs and one output. At any given moment, every terminal is in one of the two binary conditions, low (0) or high (1), represented by different voltage levels.

As used herein, an ASIC is an application-specific integrated circuit, which is an integrated circuit customized for a particular use, rather than intended for general-purpose use. The Gate-array design is a manufacturing method in which the diffused layers such as transistors and other active devices, are predefined and wafers containing such devices are held in stock prior to metallization. The physical design process then defines the interconnections of the final device. For most ASIC manufacturers, this consists of from two to as many as nine metal layers, each metal layer running perpendicular to the one below it.

As used herein, a multiplexer is a device that selects one of several analog or digital input signals and forwards the selected input into a single line. A multiplexer of 2n inputs has n select lines, which are used to select which input line to send to the output. Multiplexers are mainly used to increase the amount of data that can be sent over the network within a certain amount of time and bandwidth. A multiplexer is also called a data selector.

As used herein, a resonant LC Circuit, oscillating at its natural resonant frequency, can store electrical energy. A capacitor stores energy in the electric field between its plates, depending on the voltage across it, and an inductor stores energy in its magnetic field, depending on the current through it. If a charged capacitor is connected across an inductor, current will start to flow through the inductor, building up a magnetic field around it and reducing the charge, and therefore the voltage, on the capacitor. Eventually all the charge on the capacitor will be gone and the voltage across it will reach zero. However, the current will continue unchanged in accordance with Faraday's law of induction, which requires that for the current to change in an inductor, a voltage must be applied to it. No energy is required for this provided the current remains constant. However, as the current continues to flow, the capacitor will re-acquire charge of the opposite sign, and its terminal voltage will rise again with reversed polarity. This applies a voltage to the inductor which is now in opposition to its current, so the current now falls. The falling inductor current and rising capacitor voltage indicate a transfer of energy from the inductor to the capacitor. This is analogous to a moving mass colliding with a spring, and compressing it. When the magnetic field has completely dissipated the current will momentarily stop, and the charge will again be stored in the capacitor, with a polarity opposite to its original one. This will complete half a cycle of the oscillation. The process will then begin again in reverse, with the current flowing in the opposite direction through the inductor.

The recent advent of clock and data recovery (CDR) circuit technology has brimmed from the need to handle wider parallel bus widths across backplanes while managing clock and data skew at the receiver. Additionally, routing these signals can be difficult because they consume board space and power, and require multilayer routing schemes to manage signals and line termination. CDRs are extremely important due to the advent of new communication technologies, improvements in electrical signal processing, and the need to send multigigabit electrical signals across FR-4 and backplanes, optical, and wireless media. Communication techniques that combine clock and data prior to transmission are not new. The combination of clock and data ensure that the clock and data signals always arrive at the same time. However, the challenge is the separation of the clock and data at the receiver. This is accomplished by the CDR circuitry. Products that take data from a parallel to a serial format or vice versa are called serializers/deserializers (or “SerDes” for short). These products generally have CDR blocks to deserialize the serial data stream.

### SUMMARY OF THE INVENTION

In one aspect, this disclosure is related to a network communication system comprising a first network interface card and a second network interface card. Both the first and second network interface card include a quantum link controller that has (i) a plurality of logic gates; (ii) a plurality of signal conditioning circuits; (iii) a plurality of sequential logic circuits; and (iv) a processor. Both the first and second network interface card further includes a plurality of quantum links, wherein each quantum link includes a send circuit on the first network card and a receive circuit on the second network card, and wherein the send circuit is physically, electrically, and magnetically shielded with a quantum bit having a nano-crystal and a vacancy defect configured to house an electron; a microwave semiconductor; and a tuning circuit configured to control the input signal of the microwave semiconductor; and wherein the receive circuit is physically, electrically, and magnetically shielded and includes a quantum bit being made of a nano-crystal and containing a vacancy defect configured to house an electron; and a resonant LC circuit. Finally, both the first and second network interface card includes a clock and data recovery (CDR) circuit.

In another aspect, this disclosure is directed to a quantum communication networking device comprising an array of particles including a first particle and a second particle, wherein the first particle is entangled with the second particle, such that a change in the first particle is reflected in the second particle substantially instantaneously; and an excitation facilitator capable of inducing change within the first particle.

In another aspect, this disclosure is directed to a method of communicating using a network communication system having a first network interface card and a second network interface card comprising connecting a send circuit of the first network interface card with a receive circuit on the second network interface card. Here, the send circuit is physically, electrically, and magnetically shielded with a quantum bit having a nano-crystal and a vacancy defect configured to house an electron, a microwave semiconductor, and a tuning circuit configured to control the input signal of the microwave semiconductor; and wherein the receive circuit is physically, electrically, and magnetically shielded and includes a quantum bit being made of a nano-crystal and containing a vacancy defect configured to house an electron. The method further comprises controlling communication between the send circuit and receive circuit with a quantum link controller having: a plurality of logic gates; a plurality of signal conditioning circuits; a plurality of sequential logic circuits; and a processor.

### BRIEF DESCRIPTION OF THE DRAWINGS

The features and advantages of this disclosure, and the manner of attaining them, will be more apparent and better understood by reference to the following descriptions of the disclosed system and process, taken in conjunction with the accompanying drawings, wherein:

FIG. 1 is a diagram showing an entrapped electron bound within a carbon crystal lattice with a nitrogen vacancy gap.

FIG. 2 is a block diagram a quantum link array structure according to the disclosure.

FIG. 3 is a schematic of a signaling sequence associated with the change in electron spin according to the disclosure.

FIG. 4 is a block diagram of a quantum link controller according to the disclosure.

FIG. 5 is a diagram of a resonant LC circuit according to the disclosure.

### DETAILED DESCRIPTION

This disclosure is directed to a network interface card containing a quantum link controller, a plurality of send circuits, a plurality of receive circuits, a plurality of clock and data recovery circuits, and a plurality of unassigned circuits, which may be used for future implementation for added functionality or for testing purposes.

As seen herein, the disclosure relates generally to identifying and designing physical systems for use as quantum bits, or “qubits,” which in this application refers to the basic units of quantum information, which are critical steps in the development of a quantum-based communication device. Among the known possibilities in the solid state or physical representation of the quantum bit, a defect in diamond known as the nitrogen-vacancy (NV) center stands out for its robustness—its quantum state can be initialized, manipulated, and measured with high fidelity at room temperature.

Each send circuit on a first network interface card is entangled with a receive circuit on a second network interface card. The send circuit on the first network interface card and the receive circuit on the second network interface card are tied to their opposites on another device or devices. That is, each send circuit on the second network interface card is entangled with a receive circuit on the first network interface card. This entangled grouping of a send and receive circuit can be described as a quantum link (at times referred to herein as a “qulink”).

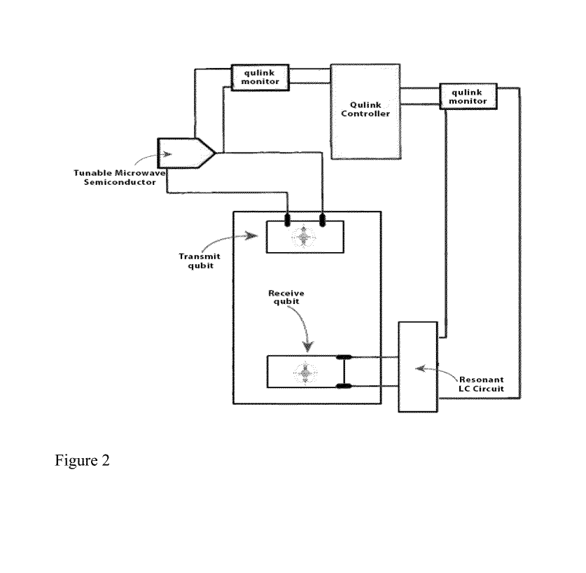

An array of quantum links may be arranged to consist of a plurality of quantum links. As shown in FIG. 2 and noted above, each quantum link comprises at least one send circuit on a first network interface card and at least one receive circuit on a second network interface card. The send circuit using a tunable microwave magnetic field manipulates the spin state of the electron in the transmit quantum bit. The receive circuit monitors and reacts to changes in the receive quantum bit.

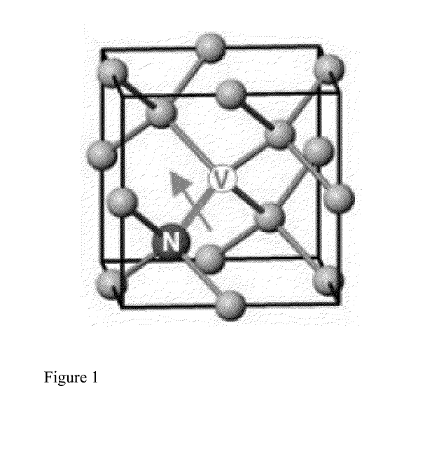

In one aspect, each send circuit is physically, electrically, and magnetically shielded and consists of a first quantum bit, a microwave semiconductor and a tuning circuit. As shown in FIG. 1, an entrapped electron may be bound in a suitable crystal lattice having a vacancy gap, such as, for example, nitrogen-vacancy centers in diamond nanocrystals. The send circuit is configured to accept input from the quantum link controller and alter the spin state of the confined entangled electron.

Further regarding the send circuit, the output of the media access controller is received on the input of the quantum link controller. The quantum link controller changes the power-levels, as needed, for the control circuit of the tunable microwave semiconductor. Adjusting the electrical values of the microwave semiconductor will affect the magnetic field interacting with the bound electron's spin state in the nitrogen vacancy gap diamond nanocrystal. This, in turn, will change the spin state of the first electron.

In another aspect, each receive circuit is also physically, electrically and magnetically shielded. It consists of a resonant LC circuit coupled directly to the non-rectifying junction contacts of a quantum bit containing an entangled electron. The receive circuit is configured to sense the change in the entangled electron spin state and pass the signal onto the quantum link controller.

The operation of the send and receive circuits will not disrupt the entanglement between the electrons, and the circuits can operate at room temperature.

Within the receive circuit, the entangled electron on the second network card simultaneously exhibits inverse properties of the entangled electron in the send circuit on the first network card. When the electron's spin state changes, it causes a change in the LC circuit's radio-frequency polarity. This shift in polarity causes a change in the signal to the input of the quantum link controller. The quantum link controller detects the change in signal and converts it as appropriate for use by the media access controller.

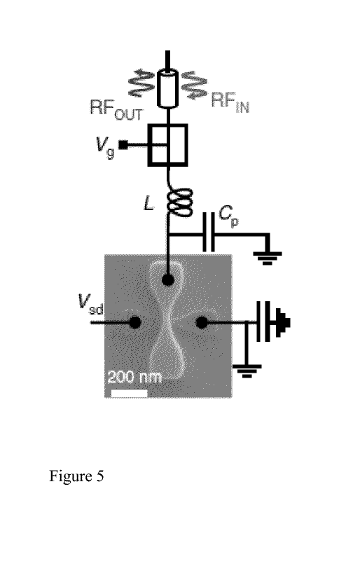

FIG. 5 is a diagram of the resonant LC circuit. More particularly, FIG. 5 displays an electron micrograph that depicts an equivalent device embedded in a resonant tank circuit. Cₚ represents the parasitic capacitance to ground and L represents a surface mount inductor. Moreover, V_{sd}, V_{g} and V_{bg} are the DC voltages applied to the source, top gate and back gate, respectively.

In yet another aspect, the network interface card of the disclosure may include a plurality of quantum links to scale the amount of data transfer capability as desired or necessary. The data rates of the quantum link connections are scaled by sending data across as many quantum links as are available.

The network interface card includes a quantum link controller that relies on a design of integrated circuits comprising logic gates, signal conditioning circuits, sequential logic circuits, and an ASIC. The quantum link controller has the following roles:

To accept a signal from a media access controller of the first network interface card and perform conversion of the signal.

To take the output from the circuitry leading from the receive circuit and convert it to the signal format needed for the input on the network card's media access controller.

To mediate activity between the quantum link controller, a media access controller, and a quantum link array.

To act as a load balancing device to distribute workloads across multiple quantum links.

To serve as a buffer for both outbound and inbound traffic.

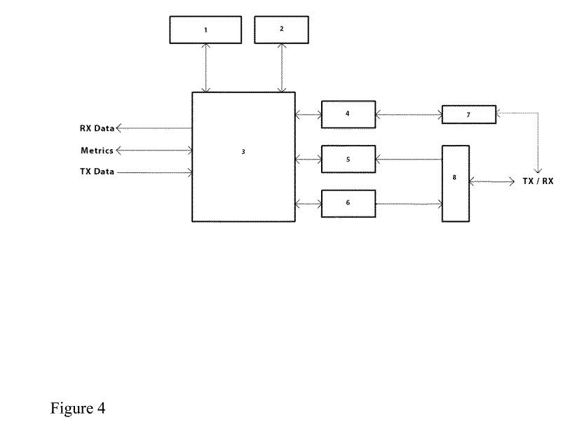

As seen in FIG. 4, a block diagram displays the quantum link controller's application-specific integrated circuit (ASIC), clock and data recovery circuit, signal conditioning circuits, and sequential logic circuits. The quantum link controller also monitors the quantum links, tracking the health and posture of the quantum links and their response times over a sliding time-span. In FIG. 4, memory (1), quantum link response flags database (2), ASIC (3), Clock and Data Recovery Circuit (4), Receive Buffer (5), Transmit Buffer (6), Clocking quantum link array (7), and Data Quantum link Array (8) may be seen.

Moreover, in one aspect, the quantum link controller may participate in a layer two (i.e., media access control/logical link layer) protocol which will be used to format the user data frames so that the quantum link controller may buffer the incoming data stream and multiplex it to one or more active quantum links. The quantum link controller may also allow for a scale-up in response to added quantum links as additional quantum links become available and scale-down in the event of a quantum link failure or data traffic congestion.

In one embodiment, each quantum link has an active connection for link management and link-state messages. The quantum link controller monitors and controls the data transfer across the quantum links and assesses the health and posture of each quantum link inside the quantum link array. A signaling protocol embedded on the ASIC is configured to establish status flags. Up/down polling signals from the first network interface card with its counterpart controller on the second network interface card will maintain these link state metrics. The link state metrics include but are not limited to active, inactive, reserved, error, quarantine, control, and a metric representing the average controller response times on that quantum link over a specified time period. These flags and response time metrics will allow the quantum link controller to make the best delivery choices based on the current status of each available quantum link pair.

### Particle Entanglement and Quantum Mechanical Interactions

Particle entanglement is accomplished using any suitable method in compliance with the details provided herein. A quantum bit is a nanocrystal made of semiconductor materials, such as, e.g., diamond, silicon or other suitable crystalline structures, that are small enough to exhibit quantum mechanical properties. Specifically, a quantum bit according to the disclosure has a vacancy gap, such as, e.g., a nitrogen vacancy gap, wherein there is an electron confined in all three spatial dimensions. The entanglement occurs when a first electron in a first quantum bit is paired with a second electron in a second quantum bit via methodologies well known in the art, the second quantum bit also being trapped in all three spatial dimensions. Nominal power is required to maintain the entangled particles within a stable carbon lattice, such as, e.g., diamond.

In one aspect, excitation of one of the entangled particles is accomplished using any suitable method that includes an excitation facilitator, such as, for example, an oscillating magnetic field. In this example, the current disclosure encompasses a network adapter that has an oscillating magnetic field inductor, an appropriately sized lattice structure, such as a carbon lattice, and a detector.

The oscillating magnetic field is used to change the spin of a first entangled particle, wherein a group of entangled particles comprises at least a first entangled particle and a second entangled particle. The change in spin of the first entangled particle is instantly reflected across the array of entangled particles. The spin state of the entangled particles can be read by using a detector.

The detector then passes information regarding the spin state onto a second circuit that will read the signal and transmit it to a generic network adapter. In particular, the second circuit is an arbitrary logic matrix where a series of quantum states is used to define a set of outputs, such as a binary output. In classical mechanics, the angular momentum of a particle possesses not only a magnitude (i.e., how fast the body is rotating), but also a direction (i.e., either up or down on the axis of rotation of the particle). As such, spin can be defined as a specific value, such as: On and Off.

This arbitrary logic matrix is then embedded into a programmable integrated circuit that, upon receiving a signal from the detector, changes in response to the signal to be able to be read by a generic network adapter as known in the art. When the generic network adapter transmits data, the arbitrary logic matrix instructs the tunable microwave semiconductor (i.e., an “induction circuit”) controlling the continuous-wave magnetic field to alter the spin state in the entangled electron.

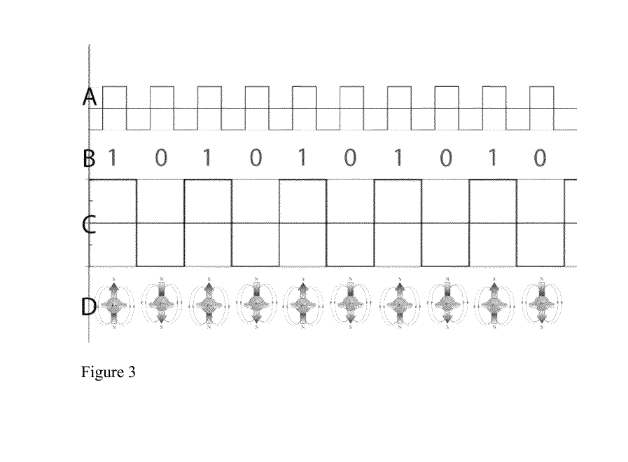

As shown in FIG. 3, line A represents the clocking signal; line B represents the binary language signal from line C; line C represents the resultant signal from the output of the quantum link controller as sent to the media access controller; and line D represents the different spin states associated with line C.

The network adapter of this disclosure utilizes a network protocol that is incorporated in the first and second layers of the IP Open Systems Interconnection (OSI) Model of the seven total OSI layers, which is a structure that characterizes and standardizes the internal functions of a communication system. These first and second OSI layers are referred to as the physical and the data link (or logical link control) network layers. This grouping is part of the media layers, whereas the other OSI layers are referred to collectively as the host layers. By changing the media layers to use the arbitrary matrix disclosed herein, communication via standard internet methods may be achieved as is generally known in the art.

One exemplary embodiment includes inducing a varying voltage across an electrical circuit comprising a quantum bit and affiliated components in order to modify oscillation in the magnetic field. In one aspect, this embodiment includes a room temperature silicon-based device able to read or detect single spin granularity and rapidly transmit spin orientation to the detector associated with an entangled electron trapped in a nitrogen vacancy gap of a carbon lattice. The resonant magnetic field of the LC circuit then switches between output ground and output to a logic circuit, which then transmits data to a converter, such as, e.g., the quantum link controller. The converter functionally checks whether the voltage is of an appropriate value that may be transmitted to any circuit well known in the art. For example, the converter transmits its output to a network media access controller.

Ethernet communication between quantum bit transistors may also be known as Ethernet over Subspace (EoSS) or Token Ring over Subspace (ToSS).

In one preferred embodiment of this disclosure, the first entangled particle may be embedded in a first network adapter, such as network cards in a router, laptop, phone, tablet, or other personal devices commonly used to facilitate communications, to which a modified version of the standard Internet Protocol can be applied. The second entangled particle may be embedded in a second network adapter, such as network cards in a router, laptop, phone, tablet, or other personal devices commonly used to facilitate communications, to which a modified version of the standard Internet Protocol can be applied. In one embodiment of the disclosure, existing technology may be used, such as commercially available oscillating continuous-wave magnetic field devices and quantum dots that are utilized as transistors, solar cells, LEDs, and diode lasers in the consumer market (e.g Sony 4K televisions). A small voltage across the leads of the quantum dots enables electron flow that can be highly regulated.

Structurally, the diamond NV comprises a carbon vacancy and an adjacent substitutional nitrogen impurity. The bound states of this deep center are multi-particle states composed of six electrons: five contributed by the four atoms surrounding the vacancy, and one captured from the bulk. The lowest energy bound state is a spin triplet whose spin sublevels differ slightly in energy. The sublevels of this ground state can be chosen to function as the quantum bit state, and coherent rotations between the two sublevels may be induced by applying microwave radiation tuned to the energy splitting between them.

In one aspect, the circuit is isolated to prevent decoherence of the entangled particles. Decoherence is caused by uncontrolled interactions between the quantum bit and the environment. This effect is usually characterized by two methods: (i) phase randomization (also known as “dephasing”) and (ii) time passage in which the excited state relaxes to the ground state by loss of energy to the environment (“relaxation time”). For electron spin quantum bits, the dephasing time is much shorter than the relaxation time and is therefore the dominant time scale for the loss of quantum correlations.

The isolation of the circuit should be as robust as possible. To optimize isolation, the disclosure includes performing operations via capacitively-coupled elements. The capacitively-coupled elements facilitate manipulation performed by short pulses applied to a proximate gate via the microwave semiconductor, and measurement performed by the resonant LC circuit. All of these aspects contribute to keeping the circuits isolated from the environment. The electrical isolation of the quantum bit results in a significantly longer coherence time than previous reports for semiconductor charge quantum bits. Further, maintaining the magneto-electric isolation will keep the entangled electrons from relaxation decoherence. Additional physical devices, such as wave guides, will be utilized as need to maximize the shielding from the environment.

In one embodiment, the oscillating magnetic fields may be used to change and measure changes in spin state by using a solid state magnetic field sensor and generator. Conceptually, this variation may be analogous to the read/write heads of a hard drive, where the write head induces a magnetic field that changes the magnetic charge on a section of the hard drive platter that can be measured by the read head.

The invention of this disclosure may be utilized with multiple solid-state entangled devices, essentially establishing a communication network wherein at least one device is broadcasting changes to the other devices on the network.

### INDUSTRIAL APPLICABILITY

The present invention relates generally to communication between two or more devices using applied quantum theory. Specifically, quantum entanglement is utilized to facilitate substantially instantaneous communication between two or more devices, such as a router, a computer, a personal electronic device, such as a phone, tablet, or other personal devices commonly used to facilitate communications. Further advantages include security and reliability, as the communication is achieved without a physical medium. Using the system as described, the result of the entanglement is analogous to a two-way radio, or a pair of transceivers.

This disclosure's quantum links and quantum link controllers may further be utilized to create serial bus connections which will provide connectivity from any location with negligible latency and heightened privacy.

In this application, a series of suitably configured peripherals consisting of an external serial bus connection-enabled module will allow users to plug one end into their existing computer and the other one into a unspecified peripheral.

As one skilled in the art will understand, combinations of the embodiments and variations of the embodiments may be combined where physically and scientifically possible to create additional methods of achieving excitation of entangled particles.

What is claimed is:

1. A network communication system comprising:
a first network interface card and a second network interface card, wherein both the first and second network interface card include:
(a) a quantum link controller, the quantum link controller having:
i. a plurality of logic gates;
ii. a plurality of signal conditioning circuits;
iii. a plurality of sequential logic circuits;
iv. a processor;
(b) a plurality of quantum links, wherein each quantum link includes a send circuit on the first network card and a receive circuit on the second network card, and wherein the send circuit is physically, electrically, and magnetically shielded with a quantum bit having a nano-crystal and a vacancy defect configured to house an electron; a microwave semiconductor; and a tuning circuit configured to control the input signal of the microwave semiconductor; and wherein the receive circuit is physically, electrically, and magnetically shielded and includes a quantum bit being made of a nano-crystal and containing a vacancy defect configured to house an electron; and a resonant LC circuit; and
(c) a clock and data recovery (CDR) circuit.

2. The network communication system of claim 1 wherein the first quantum link includes the send circuit of the first network interface card that is configured to be connected with the receive circuit of the second network interface card.

3. The network communication system of claim 1 wherein both the first network card and the second network card comprise a plurality of send circuits and a plurality of receive circuits.

4. The network communication system of claim 1 wherein the processor is an application-specific integrated circuit (ASIC) configured to control the quantum link controller.

5. The network communication system of claim 4 wherein the ASIC is configured to accept a signal from a media access controller of the first network interface card and perform conversion of the signal.

6. The network communication system of claim 4 wherein the ASIC is configured to mediate activity between the quantum link controller, a media access controller, and a quantum link array.

7. The network communication system of claim 4 wherein the ASIC is configured to act as a load balancing device configured to distribute workloads across a plurality of quantum links.

8. The network communication system of claim 1 further includes a plurality of unassigned circuits.

9. The network communication system of claim 1 wherein the crystal of the quantum bit of the send and receive circuits is a diamond nano-crystal.

10. The network communication system of claim 1 wherein the crystal of the quantum bit of the send and receive circuit is a silicon nano-crystal.

11. The network communication system of claim 1 wherein the vacancy defect of the quantum bit of the send and receive circuit is a nitrogen vacancy defect.

12. A quantum communication networking device comprising:
an array of particles including a first particle and a second particle, wherein the first particle is entangled with the second particle, such that a change in the first particle is reflected in the second particle substantially instantaneously; and
an excitation facilitator capable of inducing change within the first particle.

13. The quantum communication networking device of claim 1 further comprising a detector capable of reading the spin state of a particle.

14. The quantum communication networking device of claim 1 further wherein the excitation facilitator is an oscillating microwave magnetic field.

15. A method of communicating using a network communication system having a first network interface card and a second network interface card, the method comprising:
(a) connecting a send circuit of the first network interface card with a receive circuit on the second network interface card; wherein the send circuit is physically, electrically, and magnetically shielded with a quantum bit having a nano-crystal and a vacancy defect configured to house an electron, a microwave semiconductor, and a tuning circuit configured to control the input signal of the microwave semiconductor; and wherein the receive circuit is physically, electrically, and magnetically shielded and includes a quantum bit being made of a nano-crystal and containing a vacancy defect configured to house an electron;
(b) controlling communication between the send circuit and receive circuit with a quantum link controller having:
i. a plurality of logic gates;
ii. a plurality of signal conditioning circuits;
iii. a plurality of sequential logic circuits; and
iv. a processor.

16. The method claim 15 wherein the quantum link controller controls communication for a plurality of send circuits and a plurality of receive circuits.

17. The method of claim 15 wherein the processor is an application-specific integrated circuit (ASIC) configured to control the quantum link controller.

18. The method of claim 17 wherein the ASIC accepts a signal from a media access controller of the first network interface card and performs conversion of the signal.

19. The method of claim 17 wherein the ASIC mediates activity between the quantum link controller, a media access controller, and a quantum link array.

20. The method of claim 17 wherein the ASIC acts as a load balancing device configured to distribute workloads across a plurality of quantum links.
